(19) United States
(12) Patent Application Publication
(10) Pub. No.: US 2024/0337736 A1
(43) Pub. Date: Oct. 10, 2024

(54) Display Device With Moisture Detection Apparatus And Method For Operating Same, An Exterior Mirror, And A Motor Vehicle

(71) Applicant: MOTHERSON INNOVATIONS COMPANY LIMITED, London (GB)

(72) Inventors: Romeo WIECZOREK, Stuttgart (DE); Ralf TIEKENHEINRICH, Stuttgart (DE)

(21) Appl. No.: 18/749,851

(22) Filed: Jun. 21, 2024

Related U.S. Application Data
(63) Continuation-in-part of application No. 16/558,532, filed on Sep. 3, 2019, now Pat. No. 12,044,645.

(30) Foreign Application Priority Data
Sep. 3, 2018 (DE) 10 2018 121 454.5

(51) Int. Cl. G01S 7/497; H04N 23/52; H04N 23/63

(52) U.S. Cl. CPC G01S 7/497; H04N 23/52; H04N 23/634; G01S 2007/4975

(57) ABSTRACT

A camera system for a motor vehicle includes a camera lens, an image sensor configured to receive light from the camera lens and generate image data from the received light, a light emitting device configured to emit light onto a back side of the camera lens, and a control device. The control device may be configured to (a) cause the light emitting device to emit a pulse of light, (b) receive image data from the image sensor for (i) a first time period before the pulse of light is emitted, (ii) a second time period while the pulse of light is being emitted, and (iii) a third time period after the pulse of light has been emitted, (c) compare image data from the second time period with image data from the first and/or third time periods to determine an amount by which a brightness level increases while the pulse of light is being emitted, and (d) based on the amount by which the brightness level increases while the pulse of light is being emitted, determine whether a foreign substance is on a front side of the camera lens.

### CROSS-REFERENCE TO RELATED APPLICATION

This application is a continuation-in-part of U.S. patent application Ser. No. 16/558,532, filed Sep. 3, 2019, which claims the benefit of foreign priority to German Patent Application No. 10 2018 121 454.5, filed Sep. 3, 2019, cach of which are hereby incorporated by reference in its entirety for all purposes.

### BACKGROUND

The invention relates to a display device comprising at least one display means for moisture detection that comprises at least one lighting means for irradiating at least one element, a method for operating such a device, an exterior mirror with such a device, and a motor vehicle with such an exterior mirror, or for carrying out said method.

In modern motor vehicles, an increasing number of electronic (digital) display surfaces are being used, particularly in conjunction with (optical) measuring and assistance systems which, on the one hand, can replace the classical analog instrumentation of the motor vehicle and, on the other hand, can provide additional information and support the control and monitoring of various vehicle systems, particularly based on environmental conditions and the state of the vehicle occupants.

It has been found that these elements, such as display surfaces and systems, arc susceptible to soiling and weather-related moisture such as dew and ice when used on the exterior of the motor vehicle or at very low temperatures, high humidity, and/or a combination of these environmental conditions.

For this reason, it is desirable that moisture detection and cleaning be performed in order ensure the functioning of the display surfaces and systems and/or usability for a user. A detector system for detecting moisture is known from WO 01/31319 A1, for example.

WO 01/31319 A1 describes a detector system consisting of a sensor and at least one light source and is preferably attached to the rear window of a motor vehicle. The light source illuminates at least a portion of this window pane, and increased reflection of the light of the light source that occurs as a result of soiling, icing, and rain is registered in the sensor. Different light sources can emit different wavelengths, and the light sources can be operated with different intensities, polarizations, and/or different pulse durations. Temporal evaluation of the signals makes it possible to distinguish between different sources of contamination.

Furthermore, display devices of this generic type are known from the prior art, for example in the form of a blind spot indicator from U.S. Pat. No. 7,581,859 B2.

In these systems, however, the detection of moisture is associated with increased design complexity and energy consumption, particularly as a result of an additional detector system, as described in WO 01/31319 A1. The increased energy consumption is particularly undesirable and problematic in electric vehicles, as it significantly reduces the range of the vehicle.

### SUMMARY

It is therefore the object of the present invention to provide a moisture detection system that overcomes the disadvantages of the prior art. In particular, the simplest, most cost-effective, and smallest device for detecting moisture is to be provided in which the detection of moisture is facilitated by an integrated system, the number of parts required and the installation space are reduced, and less energy is consumed, thus enabling the efficiency of the motor vehicle to be increased and production costs reduced.

The object is achieved by the invention according to a first aspect in that the display device comprises at least one moisture detection apparatus comprising at least one sensor device, the moisture detection apparatus being designed to at least partially detect light emitted by the display means and light reflected by moisture that is present on at least a portion of the element. The term “reflected light” also includes a diffuse reflection here. The element is at least partially transparent at least in some areas, at least for light of a certain wavelength.

It is especially advantageous that the display means is capable of assuming at least one light-emitting function, the display means being capable, in particular, of taking over the displaying of at least one signal from a blind spot assist system, a travel direction indicator, a puddle light, or a camera system, particularly a TOF camera system, a status indicator, such as during autonomous driving, for example, a battery status indicator, a logo lamp, preferably on the clement, and/or the light lies in the visible, invisible, and/or infrared spectral range, and/or the element comprises, at least in part, a particularly chromium-coated reflecting surface.

It is especially preferred that the lighting means comprise at least one light source, the lighting means advantageously comprising an active or passive light source and/or a plurality of distributed light sources which, in particular, are distributed over a display region and/or in the manner of a matrix.

A provision can also be made that at least one light source comprises groups of emitters and/or regions with different spectral emission ranges, in which case, particularly for a region that is illuminated by a background light source, the spectral composition of the light emitted from the region is determined at a region that is partially absorbing the light of the background source as a result of the absorption of the partially absorbing region, and/or, for a region that is absorbing the light of the background light source, the light emitted from the region can have a spectrum that differs at least in portions from the absorbed light of the background light source by means of re-emission from the region; and/or that are operated at different intensities, polarizations, and/or different pulse durations and/or can emit in different spectral ranges.

It is also preferred in this respect that the moisture detection apparatus be able to detect a portion of a spectrum that the display means does not emit.

With the invention, it is also proposed that the display device comprise at least one dark chamber that is separated substantially almost completely from the display means in which the moisture detection apparatus is preferably housed at least partially, particularly completely. A differential measurement can be performed in order to calculate the proportion of outside light that enters the dark chamber from the outside through the cover and through any potential moisture: At a first timepoint, the sum of outside light and the light reflected by the moisture is measured and, at a second timepoint, only the outside light is measured by the moisture detection apparatus in the dark chamber. By finding the difference between the two measurement signals, the contribution of the outside light is subtracted, and the result is a measurement signal that is based on the reflected light without the influence of the outside light. In principle, this differential method can also be applied to other embodiments without the use of the dark chamber. In another embodiment, the dark chamber comprises at least one filter that is only partially transparent to at least a portion of the light emitted by the display means by means of which the spectrum of the light that is incident on the moisture detection apparatus can be adjusted, that can at least partially reflect and/or absorb light of at least a first polarization and light of at least a second polarization that differs substantially from the first polarization, and/or by means of which incident light from the outside can be attenuated and/or filtered out; or the moisture detection apparatus detects only a specific spectrum, particularly a spectrum in the infrared range. In another embodiment, the dark chamber is protected at least partially from the light that is incident from the outside by a layer that is not completely transparent, preferably not transparent, at least with respect to the light that incident from the outside.

It is advantageously possible for the display device to comprise at least one capacitive sensor element that is designed to detect moisture, the capacitive sensor element preferably comprising at least two electrodes and/or being formed at least in part by existing components, particularly components of the display device and/or display means.

It is especially preferred, in turn, that that the display device comprise at least one control device and/or at least one computer unit, the control device being preferably designed to be operatively connected to and/or to actuate and/or control at least one device for removing moisture, particularly the heating device, cleaning device, and/or vibration device, display device, particularly the display means and/or moisture detection apparatus, and/or the capacitive sensor element, and/or being integrated at least partially into the moisture detection apparatus or the display means, and/or evaluating data supplied to the control device and/or computer unit and forwarding it to the control device and/or other devices.

A method can also be provided that is characterized by the execution of the steps of activation of the display means, measurement, and moisture detection, wherein the step of the activation of the display means preferably comprises operation of the display means at different intensities, different polarizations, different pulse durations, and/or different spectral ranges, wherein the step of measurement is carried out multiple times, and wherein the step of moisture detection comprises the analysis of different emissions and detections, particularly for the purpose of distinguishing different forms of moisture and/or of improving the detection of moisture; during the step of moisture detection, the value that was measured and/or further processed during the step of measurement is compared to a reference value, particularly a reference value that has been established by the manufacturer, calibrated in the plant after manufacturing, or generated by other means, and/or, after the step of moisture detection, the heating device, the means for removing moisture, and/or a warning function is activated as needed.

It can also be especially preferred, in turn, that the element, particularly the cover, be at least partially transparent, preferably substantially completely transparent, to emitted light of certain wavelengths of a spectrum emitted by the display device and comprise at least one outer surface that is positioned on the side facing away from the interior of the exterior mirror and is exposed to the outside influences of the environment; the coating be applied on the side of the cover facing away from the outer surface, it being possible for the coating to be interrupted and/or lessened in order to at least partially transmit the light of the display device; and the exterior mirror comprise at least one heating device, particularly comprising at least one heating coil, at least one coating and/or at least one heating foil, at least one cleaning device, particularly comprising at least one brush, at least one wiper, and/or at least one nozzle, and/or at least one vibrating device, particularly at least one motor, at least one piezoelectric actuator, and/or at least one sound source, particularly at least one ultrasound source.

Furthermore, it can be advantageous that the element, in particular the cover, comprise at least one symbol region for displaying a display signal from the display device, at least one EC glass, at least one display, and/or at least a portion of an EC glass or of a display.

As an embodiment, the invention further proposes that the coating comprise at least one reflective coating, in particular at least one chromium coating, at least one coating that is absorbent for at least for a specific spectral range, at least one antireflection coating, at least one transmitting coating, and/or at least one coating that is electrically conductive and advantageously transparent at least for a specific spectral range, in particular a coating comprising transparent, electrically conductive oxides such as indium-tin oxide, carbon nanotubes, and/or electrically conductive polymers.

And it can also be especially preferred that at least a portion of the electrically conductive coating form at least a portion of at least one capacitive sensor element and/or function as a heating device.

According to the invention, it can also be preferred that the exterior mirror comprise more than one display device, and that the display devices, in particular the light and measurement signals of a plurality of display devices, be operatively connected to one another for the purpose of detecting moisture.

Here again, a provision can be made that the exterior mirror comprises at least one capacitive sensor element that is designed to detect moisture, particularly by measuring a dielectric constant of a dielectric, comprising at least a portion of the element, preferably of the cover, particularly a portion of the outer surface of the element, as well as moisture located on the at least one portion of the element, the capacitive sensor element preferably comprising at least two electrodes and/or being formed at least in part by existing components, particularly by components of the display device, the display means, and/or the exterior mirror.

It is likewise advantageously possible for the exterior mirror to comprise at least one control device and/or at least one computer unit, in which case the control device is preferably designed to be operatively connected to and/or to actuate and/or control at least one device for removing moisture, particularly heating device, cleaning device, and/or vibration device, at least one display device, particularly the display means, and/or moisture detection apparatus, and/or at least one capacitive sensor element, and evaluates data supplied to the control device and/or computer unit and forwards it to the control device and/or other devices.

For the purposes of the present invention, the term “moisture” encompasses any form of surface fouling formed by temperature and/or atmospheric composition, in particular by precipitation, that deposits on objects, for example through condensation and/or resublimation, and/or, particularly in solid form, settles and/or accumulates on objects and can be released by changes in temperature. Forms of such moisture include ice, snow, dew (fog), rime, and frost, for example. However, the term “moisture” also includes dirt and other contaminants that can settle and/or accumulate on surfaces and can be removed by means of a cleaning device comprising a wiper, a brush, and/or a nozzle, for example, and/or by means of a vibrating device comprising a motor, a piezoelectric actuator, and/or a sound source, particularly an ultrasound source, for example.

For the purposes of the present invention, the term “light” encompasses not only the visible and infrared spectrum, but also any form of wave, in particular electromagnetic waves and/or sound waves, that the display means emit and that can be reflected by moisture. Here, the term “reflect” also includes scattering, refracting, bending, and/or absorbing and re-emitting the waves so that they can be received by an appropriately positioned detector.

In addition to the conventional exterior mirror, “exterior mirrors” also include any form of exterior mirror system used in motor vehicles, particularly in the form of camera-based exterior mirror replacement systems, including with integrated display technologies that are arranged at least partially on the exterior of the motor vehicle.

According to the invention, a method is provided for operating a display device, particularly in an exterior mirror of a motor vehicle, that comprises in particular a display means and a moisture detection apparatus and in which at least the steps of activating a display means comprising at least one moisture detection apparatus and at least one sensor device; and measurement and moisture detection by means of the moisture detection apparatus, which at least partially detects a light emitted by the display means and light reflected by a moisture that is present.

In one embodiment of the method, the method includes the additional steps of measuring a first signal for the sum of outside light and the light reflected by the moisture at a first timepoint; measuring a second signal only for the outside light, with the display means not emitting any light, at a second timepoint; and finding the difference between the two signals, thereby subtracting the contribution of the outside light and providing a differential signal based solely on the light reflected by the moisture without the influence of the outside light. The differential method enables reflected light to be detected even when the moisture detection apparatus is exposed to sunlight from the outside.

In another embodiment of the method, the step of moisture detection comprises the detection of a type of moisture, the type of moisture being identified as water in the case of a high differential signal and as ice in the case of a correspondingly lower differential signal. An exterior mirror according to the invention can be equipped with one or a plurality of display devices that are designed to carry out a method according to the invention of the type described.

A motor vehicle according to the invention can be equipped with one or a plurality of exterior mirrors with one or a plurality of display devices that are designed to carry out a method according to the invention of the type described.

Embodiments of the disclosure provide a camera system for a motor vehicle that includes a camera lens, an image sensor configured to receive light from the camera lens and generate image data from the received light, a light emitting device (e.g., a light emitting diode) configured to emit light onto a back side of the camera lens, and a control device. In embodiments, the control device may be configured to (a) cause the light emitting device to emit a pulse of light, (b) receive image data from the image sensor for (i) a first time period before the pulse of light is emitted, (ii) a second time period while the pulse of light is being emitted, and (iii) a third time period after the pulse of light has been emitted, (c) compare image data from the second time period with image data from the first and/or third time periods to determine an amount by which a brightness level increases while the pulse of light is being emitted, and (d) based on the amount by which the brightness level increases while the pulse of light is being emitted, determine whether a foreign substance is on a front side of the camera lens. In embodiments, the increase in brightness level is caused by light from the light emitting device being reflected off the of the camera lens, and the increase in brightness level is less when a foreign substance is on the front side of the camera lens than when no foreign substance is on the front side of the camera lens.

In embodiments, the control device may be configured to repeat processes (a)-(d) at a regular time interval. The regular time interval may be selected so as not to cause an interruption in the camera image that is perceptible by the driver of the vehicle. For example, in an embodiment the image sensor may be configured to capture image data at a frame rate that is greater than or equal to 60 frames per second (fps) and the regular time interval may be greater than or equal to. 0.5 seconds.

In embodiments, the camera system may further include a heating device configured to heat the camera lens, and the control device may be further configured to cause the heating device to turn on, heating the camera lens, based on a determination that a foreign substance in on the front side of the camera lens. In further embodiments, the control device may be configured to repeat processes (a)-(d) after the camera lens has been heated by the heating device, and based on another determination that the foreign substance is on the front side of the camera lens, generate an alarm message. The alarm message may be displayed to a driver of the vehicle indicating that the foreign substance is on the camera lens.

In embodiments, the control device may be further configured to distinguish between two or more types of foreign substance based on the amount by which the brightness level increases while the pulse of light is being emitted. The control device may be further configured to cause a heating device to turn on, heating the camera lens, based on a determination that a water-based type of foreign substance is on the front side of the camera lens. In embodiments, the control device may be configured to generate an alarm message based on a determination that a non-water-based type of foreign substance is on the front side of the camera lens. In other embodiments, the control device may be configured to cause water to be sprayed on the camera lens based on a determination that a non-water-based type of foreign substance is on the front side of the camera lens.

Embodiments of the disclosure provide a method of detecting foreign substances on a camera lens of a camera system for a motor vehicle that comprises: emitting a pulse of light onto a back side of the camera lens; measuring a first brightness level of light received from the camera lens during a first time period before the pulse of light is emitted; measuring a second brightness level of light received from the camera lens during a second time period while the pulse of light is being emitted; measuring a third brightness level of light received from the camera lens during a third time period after the pulse of light has been emitted; comparing the second brightness level with the first and/or third brightness levels to determine an amount by which brightness increases while the pulse of light is being emitted; and based on the amount by which brightness increases while the pulse of light is being emitted, determining whether a foreign substance is on a front side of the camera lens. In embodiments, the method may further include the operation of causing the camera lens to be heated based on a determination that a foreign substance is on the front side of the camera lens. In embodiment, the steps of the method may be repeated after the camera lens has been heated, and based on a subsequent determination that the foreign substance is on the front side of the camera lens after the camera lens has been heated, an alarm message may be generated.

### BRIEF DESCRIPTION OF THE DRAWINGS

Preferred embodiments of the present invention will be described in the following by way of example with reference to schematic drawings, in which

FIG. 1 shows a sectional view of a portion of an exterior mirror of a motor vehicle with a first embodiment of a device according to the invention;

FIG. 2 shows a sectional view of portion of an exterior mirror of a motor vehicle with a second embodiment of a device according to the invention;

FIG. 3 shows a block diagram of a method according to the invention;

FIG. 4 illustrates another example camera system for a motor vehicle that is configured to detect foreign substances, such as water, fog or dirt, on the camera lens; and

FIGS. 5A-6B illustrate an example of how the camera system of FIG. 4 may be used to detect the presence of a foreign substance on a camera lens.

### DETAILED DESCRIPTION

Although the embodiments are explained below with reference to an exterior mirror, the underlying invention can also be used in other areas and components.

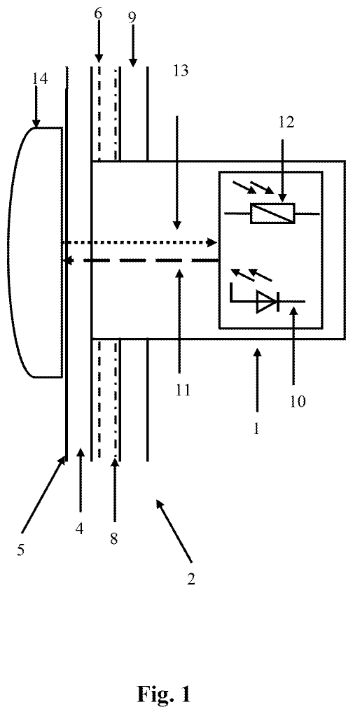

FIG. 1 shows a sectional view of a portion of an exterior mirror of a motor vehicle with

a first embodiment of a display device 1 according to the invention. The exterior mirror 2 comprises a cover 4, which represents an element on the outer surface 5 of which moisture can form. Furthermore, the exterior mirror 2 comprises a coating 6, a heating device 8, and a carrier material 9. The cover 4 is at least partially transparent, preferably substantially completely transparent, for emitted light of specific wavelengths of a spectrum that is emitted by the display device 1. In particular, the material of the cover can also include glass, at least in part. An outer surface 5 of the cover 4 is positioned on the side facing away from the interior of the exterior mirror and thus exposed to the external influences of the environment.

The coating 6 is applied to the side facing away from the outer surface 5 of the cover 4 and can be interrupted and/or lessened in order to allow the light of the display device 1 through. In particular, the coating 6 can comprise a reflective coating for a mirror element, e.g., a chromium coating. The coating 6 can also have a coating that is absorbent at least for a specific spectral range, an antireflective coating, a transmitting coating, and/or a coating that is electrically conductive and advantageously transparent for at least one specific spectral range, c.g., a coating of transparent, electrically conductive oxides such as indium tin oxide, carbon nanotubes, and/or electrically conductive polymers. In particular, an electrically conductive coating can also function as a heating device 8.

The heating device 8 is designed such that it can change the temperature of the cover 4 in such a way that a moisture present on the outer surface 5 is dispersed. In particular, the heating device 8 is arranged in substantially laminar fashion beneath the cover 4, for example in the form of a heating coil, a coating, or a heating foil. The heating device 8 is connected to a control device (not shown), particularly to a control device of a motor vehicle that controls the heating device 8.

The display device 1 comprises a display means 10 and a moisture detection apparatus 12. The display means 10 is designed to assume different light-emitting functions, particularly the emission of light in the visible and/or infrared spectral range, c.g., the displaying of a signal from a blind spot assist system, a travel direction indicator, a puddle light, a camera system, particularly a TOF camera system. The display means comprises at least one lighting means. A lighting means is a device for emitting light and thus particularly comprises active light sources, such as incandescent and light-emitting diodes, and passive light sources, such as light conductors or waveguides. It is especially advantageous in this context if the lighting means of the display means provides light sources that are distributed in particular over a display region. In the case of a display means that is based on a particularly matrix-like distribution of light sources, the light sources comprising groups of emitters and/or regions with different spectral emission ranges, spectral emitters for the spectral range of moisture detection can be provided, and/or the existing groups of emitters and/or regions that can provide at least a portion of the spectral range for moisture detection are activated. Such an emitter for a display means can also constitute or comprise an absorbing region in which the spectral composition of the light emitted from the region is determined for a region that is illuminated by a background light source through the partial absorption of the light of the background light source by the partially absorbing region. It is also possible for such an emitter to comprise a re-emission that is triggered by the absorption of light, particularly by the absorption of light from a background light source, in a spectrum that differs at least partially from the absorbed light from the background light source. A combination—and even a stacking—of emitting, absorbing, and re-emitting regions is likewise possible. Light sources can be operated at different intensities, polarizations, and/or different pulse durations and/or emit in different spectral ranges. Through the particularly temporal evaluation of different emissions, it is possible to differentiate different types of moisture and/or to improve the detection of moisture.

The moisture detection apparatus 12 comprises at least one sensor device that is designed to be able to detect at least a portion of the light emitted by the display means 10. The moisture detection apparatus 12 is connected to a control device (not shown). In particular, the control device can also actuate and/or control devices for removing moisture, such as heating devices, cleaning devices, and/or vibration devices, for example. The control device can also be integrated into the moisture detection apparatus 12 or the display means 10, and/or it can also be identical to or connected in particular to a control device of a motor vehicle, particularly to the control device that controls the heating device 8. For the sake of example, the circuit symbols for an LED are shown as the display means and the circuit symbols for a photoresistor are shown as the moisture detection apparatus.

The display device 1 is connected to the exterior mirror 2 in such a way that at least a portion of the light 11 emitted by the display means 10 is allowed to get outside via the cover 4, preferably via a cutout, particularly through the carrier material 9, the heating device 8, and the coating 6. If, as is shown in FIG. 1, moisture 14 is present on the cover 4, a portion of the light 11 emitted by the display means 10 can be reflected on the moisture 14 and detected as a reflected light 13 by the moisture detection apparatus 12. In general, the portion of the light that is reflected on the moisture will increase the total amount of light emitted by the display means 10 and detected by the moisture detection apparatus 12. By selecting the spectrum of the light of the display means 10 for moisture detection, particularly through selection of a spectrum in the non-visible range, through the timing of the activation of the moisture detection apparatus 12 and the display means 10, and/or by tuning the moisture detection apparatus 12 to a portion of the light spectrum emitted by the display means 10 and typically reflected by moisture, the moisture detection can be advantageously improved. A provision can also be made that—particularly in the case that the moisture absorbs a certain portion of the spectrum of the light emitted by the display means 10 and re-emits a spectrum that differs from the absorbing portion of the spectrum—the moisture detection apparatus 12 can detect a portion of a spectrum that the display means 10 is not emitting.

As an alternative or in addition to the heating device 8, a cleaning device (not shown here), particularly comprising a brush, a wiper, and/or a nozzle, can be attached to the outside of the exterior mirror in order to mechanically remove the moisture.

As an alternative or in addition to the heating device 8 and/or the cleaning device, the exterior mirror can comprise a vibration device such as a motor, a piezoelectric actuator, and/or a sound source-particularly an ultrasound source-that can cause the cover 4 and/or the moisture to vibrate. This makes it possible for at least a portion of the moisture to be removed from the surface.

The cover 4 can also comprise an EC glass, a display, and/or a portion of an EC glass or of a display.

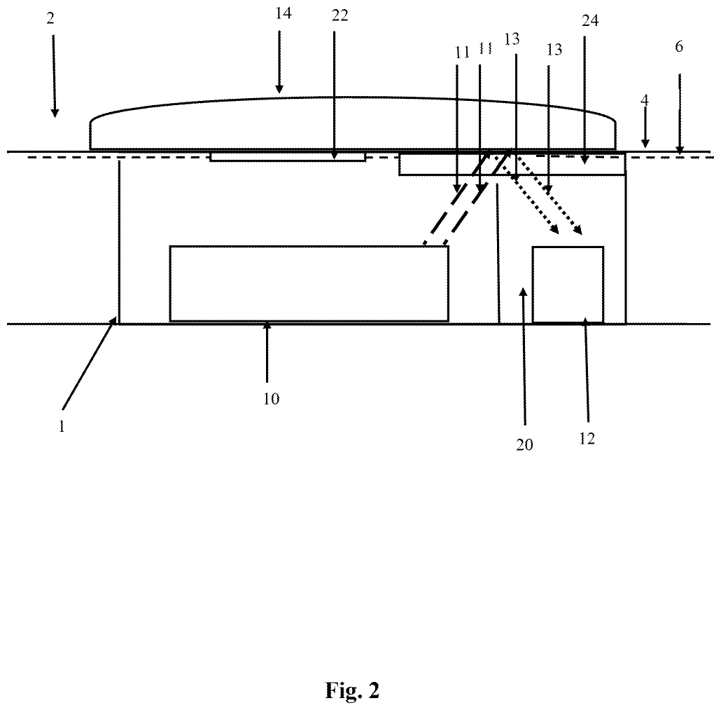

FIG. 2 shows a second embodiment of a display device 1 according to the invention as part of an exterior mirror 2 of a motor vehicle. The exterior mirror 2 is substantially the same as in the first embodiment and, for greater clarity, some of the components shown in FIG. 1 are not shown. The exterior mirror 2, particularly the cover 4, comprises a symbol region 22 for displaying a display signal from the display device 1. In the symbol region 22, the coating 6 can be interrupted and/or lessened in order to allow the light of the display device through, in which case the coating 6 is interrupted and/or lessened particularly in the form of a symbol for the display of the display device. The display device 1 comprises a display means 10, particularly in the form of a light source and/or light conductor, as well as a dark chamber 20 that is separated from the display means and in which the moisture detection apparatus 12 is housed. If there is moisture 14 on the outer surface of the cover 4, light 11 emitted by the display means 10 is reflected on the moisture 14 into the dark chamber 20, where the reflected light 13 can be detected by the moisture detection apparatus 12. In this embodiment, the dark chamber 20 is delimited on the side facing toward the outside by a filter 24 and defines a measurement range, the filter being at least partially transparent, in particular substantially completely transparent, for the light 11 that is emitted by the display means 10. The coating 6 can also be interrupted and/or lessened in the vicinity of the filter, particularly if the coating 6 is not substantially permeable for the light 11, but reflective. If there is moisture 14 on the outer surface of the cover 4, light 11 emitted by the display means 10 is reflected on the moisture 14 through the filter 24 into the dark chamber 20, where the reflected light 13 can be detected by the moisture detection apparatus 12. The filter can be used to set the spectrum of the light that is incident on the moisture detection apparatus. In particular, this also makes it possible for light that is incident from the outside to be attenuated and/or filtered out. Advantageously, the filter is an IR filter, and the display device 10 emits light in the non-visible infrared range, inter alia. Functionally speaking, the measurement range could also be operated without a filter 24, particularly even without a coating 6, if the moisture detection apparatus 12 only detects a specific spectrum, particularly a spectrum in the infrared range.

However, the filter 24 can also be configured to transmit light of a first polarization and to reflect and/or absorb light of at least a second polarization that differs from the first. The filter can thus be designed to reflect and/or absorb the light of the display means 10 and be mounted directly over the moisture detection apparatus 12, with the effect that the light emitted by the display means 10 does not pass directly through the filter and does not reach the moisture detection apparatus 12. However, if the light emitted in this way is reflected by an object, particularly a moisture, with a simultaneous change in the polarization, at least a portion of the reflected light is able to pass through the filter and the moisture can be detected by the moisture detection apparatus.

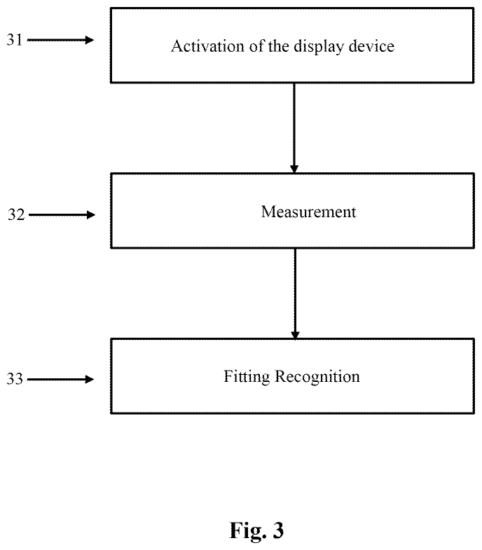

A method according to the invention for detecting moisture is shown schematically in FIG. 3. The method comprises at least the steps of activation of the display means 31, measurement 32, and moisture detection 33, with the heating device, the cleaning device, and/or the vibrating device being activated as needed in order to disperse the moisture. The method can be employed separately for the detection of moisture or even also when the display device is activated for its actual function. Alternatively or in addition, a warning function can be triggered.

During the step of the activation of the display means 31, the display means is activated in order to emit light to the outside. If there is moisture on the cover, a portion of the emitted light can be reflected back.

Alternatively or in addition, the display means can be operated at different intensities, polarizations, and/or different pulse durations and/or emit in different spectral ranges. By selecting the spectral range of the light of the display means for moisture detection, particularly through selection of a spectrum in the non-visible range, through the timing of the activation of the moisture detection apparatus 12 and the display means 10, and/or by tuning the moisture detection apparatus 12 to a portion of the light spectrum emitted by the display means 10 and typically reflected by moisture, the moisture detection can be advantageously improved.

During the step of measurement 32, the moisture detection apparatus and/or a capacitive sensor element that may be present is activated for moisture detection in order to detect the light that is incident on the moisture detection apparatus, particularly to measure the intensity, polarization, wavelength, pulse duration, and/or spectral range of the light that is incident on the moisture detection apparatus and/or to detect moisture based on the measurement of the capacitive sensor element. Through the particularly temporal evaluation of different emissions and detections, it is also possible to differentiate different types of moisture and/or to improve the detection of moisture.

During the step of moisture detection 33, the reflection intensity is calculated; in particular, the value measured or already further processed during the measurement step is compared to a reference value. This reference value can either have been established by the manufacturer, calibrated in the plant after the manufacture of the display device, of the exterior mirror, and/or of the motor vehicle, or generated by other means and/or stored in a memory device. For instance, the step of measuring the intensity can be carried out multiple times in the method in order to obtain additional reference values without an activated display means, particularly before the step of activating the display means. The intensity of the light reflected by moisture can thus be determined particularly through subtraction.

Even when parking, particularly when closing, a motor vehicle comprising an exterior mirror that comprises such a display device according to the invention with moisture detection apparatus, a reference value can be generated through activation of the display means and the moisture detection apparatus and stored which-particularly upon subsequent activation of the display means and/or of the moisture detection apparatus, advantageously upon opening of the motor vehicle—can be used to detect moisture that has formed in the time between the parking of the motor vehicle and the time of moisture detection. A respective reference value without activation of the display means is advantageously also generated and stored for this purpose.

The method is carried out by a control device that is preferably integrated into the display device. However, the control device can also be integrated into the exterior mirror or motor vehicle and connected to the display device via a communication system. In particular, the control device can also actuate and/or control devices for removing moisture, such as heating devices, cleaning devices, and/or vibration devices, for example, as well as display devices, particularly display means and/or moisture detection apparatuses, and capacitive sensor elements. A computer unit can also be provided. The computer unit evaluates the data supplied to it and/or to the control device and then forwards them to the control device and/or other devices. The computer unit can also be a subunit of the control device and/or already be integrated into same. Various evaluation algorithms—particularly subtraction—can be used to evaluate the data.

Advantageously, an exterior mirror is equipped with more than one display device. The use of multiple display devices for moisture detection results in an increased probability of detection, particularly of moisture over a large surface, if a plurality of display devices identify moisture at the same time or in rapid succession.

It is also possible for the moisture to have the effect that the light of one display device is received or no longer received from the moisture detection apparatus of another display device, particularly as a result of total reflection or impeded total reflection. The connection between a plurality of display devices, particularly the light and measurement signals of a plurality of display devices, can thus not only enable moisture to be identified, but particularly also the location, distribution, and extent of moisture to be identified as well.

Advantageously, a display device and/or the exterior mirror can also comprise a capacitive sensor element that is designed to detect moisture, particularly through the measurement of a dielectric constant of a dielectric, comprising at least a portion of the cover, particularly a portion of the outer surface of the cover, as well as moisture located on the cover. In particular, the capacitive sensor element can be instantiated in the form of two electrodes that can form a capacitor together with the dielectric. When moisture is present, particularly in the form of a polar liquid such as water, for example, the dielectric constant of the capacitor changes measurably. In particular, the capacitive sensor element can also be formed at least in part, by already existing components, particularly by components of the display device and/or display means. As a specific example, a heating device—e.g., two electrically unconnected or separable heating electrodes of a heating device of an exterior mirror—can act as a capacitive sensor. It is also possible for portions of an electrically conductive coating to act at least as part of a capacitive sensor element.

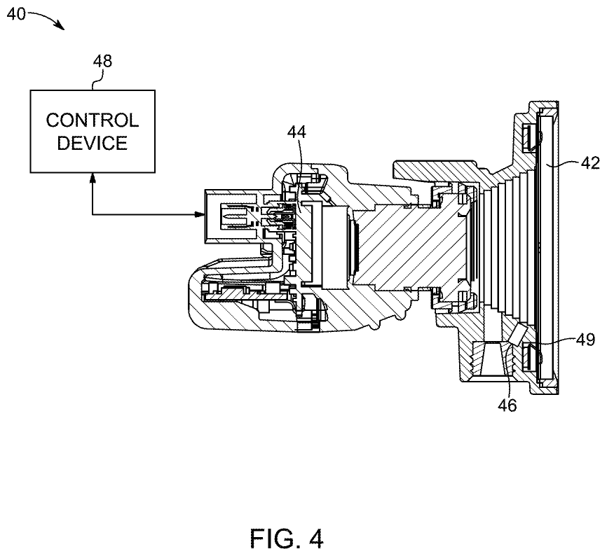

FIG. 4 illustrates another example camera system 40 for a motor vehicle that is configured to detect foreign substances, such as water, fog or dirt, on the camera lens 42. As shown in FIG. 4, the camera system 40 includes the camera lens 42 and an image sensor 44 that is configured to receive light from the camera lens 42 and generate image data from the received light. The example camera system 40 further includes a light emitting device 46, such as a light emitting diode (LED), that is configured to emit light onto a back side of the camera lens 42, and a control device 48 that is configured to detect if a foreign substance is on the camera lens 42 based the intensity of light from the light emitting device 46 that is reflected off of the camera lens 42 and received by the image sensor 44.

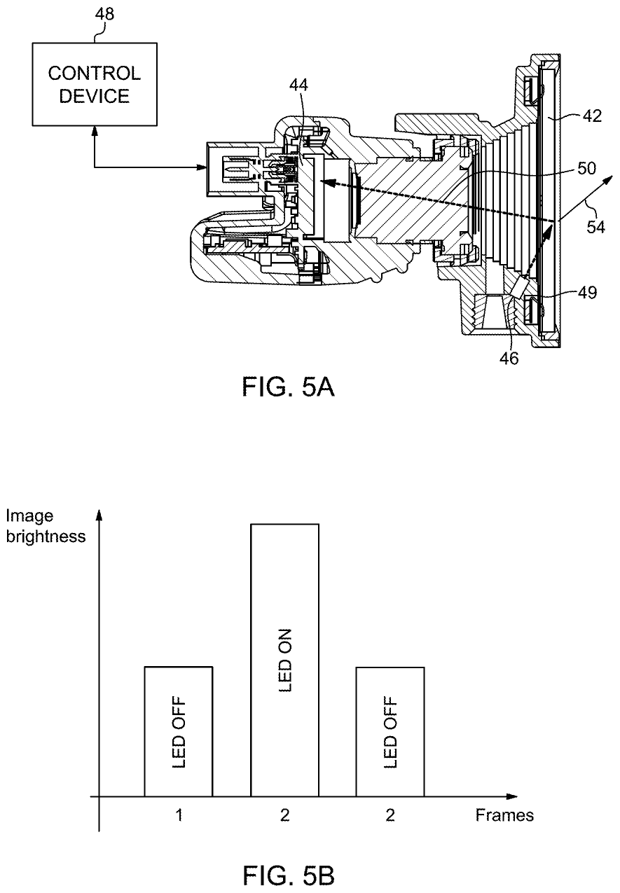

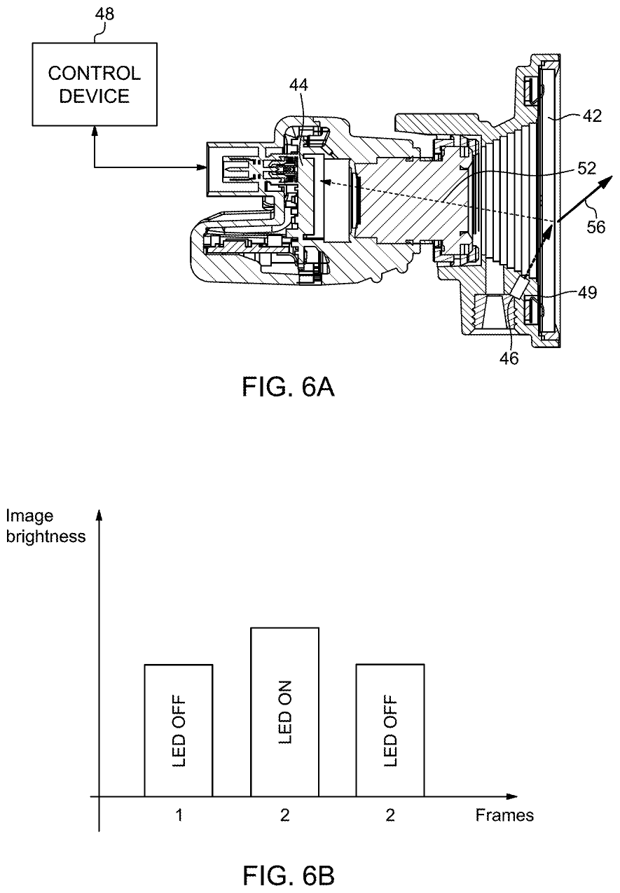

For example, in an embodiment the control device 48 may be configured to cause the light emitting device 46 to emit a pulse of light, and compare image data from the image sensor 48 during the pulse of light to image data before and after the pulse of light is emitted to determine an amount by which a brightness level increases while the pulse of light is being emitted. Based on the amount by which the brightness level increases while the pulse of light is being emitted, the control device 48 may determine whether a foreign substance is on a front side of the camera lens 42, for example as illustrated in FIGS. 5A-6B. In embodiments, the control device 48 may be a processing device (such as a microprocessor, microcontroller, ASIC, etc.) that is included as part of a camera system assembly or that is included as part of a camera system having multiple camera assemblies.

In embodiments, the control device 48 may be configured to turn on the light emitting device 46 for a short time period at regular time intervals. For example, in embodiments the image sensor 44 may be configured to capture image data at 60 frames per second (fps), and the control device 48 may be configured to turn on the light emitting device 46 for one or two frames per second. In this way, the image sensor 44, which during normal operation is used to generate a camera image that is displayed to a driver of the vehicle, can also be utilized by the control device 48 for detecting foreign substances on the camera lens 42 without causing a perceptible interruption in the camera image being displayed to the driver. In other embodiments, the process for detecting foreign substances on the camera lens 42 could only be utilized during start-up or when manually started by the driver in order to further prevent interruption to the displayed camera image.

As shown in FIG. 4, the camera system 40 may include a heating device 49 for heating the camera lens 42 to remove water-based substances, such as ice, water, fog, etc. In embodiments, the control device 48 may be further configured to cause the heating device 49 to turn on, heating the camera lens 42, based on a determination that a foreign substance is on the front side of the camera lens 42. In embodiments, if heating the camera lens 42 does not cause the foreign substance to be removed from the lens, then the control device 48 may generate an alarm message to the vehicle driver to manually clean the camera lens 42. For example, if the control device 48 detects a foreign substance on the camera lens 42 during one or more cycles of the detection process, the system may first treat the foreign substance as a water-based substance by heating the camera lens 42. Then, if during subsequent cycles of the detection process after heating, the control device 48 continues to detect the foreign substance on the camera lens 42, it may then conclude that the foreign substance is a non-water-based substance, such as dirt, that cannot be resolved by heating, and consequently generate an alarm message to the driver to clean the lens. Alternatively, if the camera system 40 includes a mechanism to clean non-water-based substances from the camera lens 42, such as a mechanism to spray water onto the lens, then the control device 48 may be configured to activate such cleaning mechanism if the foreign substance is not removed by heating.

FIGS. 5A-6B illustrate an example of how the camera system 40 of FIG. 4 may be used to detect the presence of a foreign substance on the camera lens 42. Specifically, FIGS. 5A and 5B illustrate an example operation of the camera system 40 when the camera lens 42 is clean, and FIGS. 6A and 6B illustrate an example operation of the camera system 40 when there is a foreign substance (e.g., ice, water, fog, dirt, etc.) on the camera lens 42. As shown in FIGS. 5A and 6A, when light is emitted from the light emitting device 46 onto the back side of the camera lens 42, a portion 50, 52 of the emitted light is reflected off of the camera lens 42 back towards the image sensor 44, and a portion 54, 56 of the emitted light passes through the front side of the camera lens 42 into the environment. The presence of a foreign substance on the camera lens 42 will cause less of the emitted light to be reflected off of the camera lens 42 towards the image sensor 44. Thus, in the illustrated example, the reflected light 50 from the clean lens 42 in FIG. 5A is more intense that the reflected light 52 from the polluted lens 42 in FIG. 6A. The image sensor 44 data may therefore be used to detect a foreign substance on the camera lens 42 by monitoring the intensity (i.e., brightness) of the reflected light 50, 52, as shown for example in FIGS. 5B and 6B.

FIGS. 5B and 6B cach illustrate three frames of image data (Frames 1, 2, and 3) that are captured by the image sensor 44, and that include a frame of image data (Frame 2) that is captured while the light emitting device 46 is on causing light 50, 52 to be reflected off of the camera lens 42, along with frames of image data (Frames 1 and 3) that are respectively captured by the image sensor 44 before and after the light emitting device 46 is turned on. In one embodiment, the control device 48 may determine if a foreign substance is on the camera lens 42 based on an amount by which the brightness level increases while the light emitting device 46 is turned on. For example, the control device 48 may determine that the lens is clean if the brightness level increases more than a threshold amount when the light emitting device 46 is on (e.g., as shown in FIG. 5B), and may determine that the lens is polluted if the brightness level does not increase by a threshold amount when the light emitting device 46 is on (e.g., as shown in FIG. 6B).

In another embodiment, by comparing the brightness level of the image data when the light emitting device 46 is turned on with the brightness levels of the image data before and after the light emitting device 46 is on, the control device 48 may isolate a brightness level caused by the reflected light 50, 52 (e.g., by subtracting or otherwise filtering out the brightness caused by light entering from the environment outside of the camera system 40). Then, by monitoring the brightness level of the reflected light 50, 52 over multiple frame intervals, the control device 48 can detect changes in brightness caused by a foreign substance on the camera lens 42. For example, comparing the clean lens in FIGS. 5A and 5B with the polluted lens in FIGS. 6A and 6B, it is shown that the brightness level of the reflected light 50, 52 decreases when a foreign substance is on the camera lens 42. Therefore, in embodiments, the control device 48 may identify a foreign substance on the camera lens 42 based on detecting a decrease in the brightness level of the reflected light 50, 52, for example by determining that the brightness level of reflected light 50, 52 has decreased more than a predetermined threshold amount over a predetermined number of frame intervals. In another example, the control device 48 may identify a foreign substance on the camera lens 42 based on detecting that the brightness level of the reflected light 50, 52 has fallen below a predetermined threshold level.

In one alternative embodiment, the control device may be further configured to distinguish between two or more types of foreign substances based on the amount by which the brightness level increases while the pulse of light is being emitted from the light emitting device 46. For example, a detected brightness level within a first predetermined range may be attributed to a water-based foreign substance, and a detected brightness level within a second predetermined range may be attributed to a non-water-based foreign substance. In this embodiment, the control device may be configured to cause a heating device to turn on, heating the camera lens, based on a determination that a water-based type of foreign substance is on the front side of the camera lens, and may be further configured to generate an alarm message or activate a cleaning mechanism (e.g., a water spray) based on a determination that a non-water-based type of foreign substance is on the front side of the camera lens.

The features of the invention that are disclosed in the foregoing description, in the drawings, and in the claims can be essential both individually and in any combination for the implementation of the invention in its various embodiments.

### List of Reference Numbers

1 display device
2 exterior mirror
4 element, e.g., a cover
5 outer surface
6 coating
8 heating device
9 carrier material
10 display means
11 emitted light
12 moisture detection apparatus
13 reflected light
14 moisture
20 dark chamber
22 symbol region
24 filter
31, 32, 33 method steps
40 camera system
42 camera lens
44 image sensor
46 lighting emitting device
48 control device
49 heating device
50, 52 reflected light
54,56 non-reflected light

What is claimed is:

1. A camera system for a motor vehicle, comprising:
a camera lens;
an image sensor configured to receive light from the camera lens and generate image data from the received light;
a light emitting device configured to emit light onto a back side of the camera lens; and
a control device configured to
(a) cause the light emitting device to emit a pulse of light,
(b) receive image data from the image sensor for (i) a first time period before the pulse of light is emitted, (ii) a second time period while the pulse of light is being emitted, and (iii) a third time period after the pulse of light has been emitted,
(c) compare image data from the second time period with image data from the first and/or third time periods to determine an amount by which a brightness level increases while the pulse of light is being emitted, and
(d) based on the amount by which the brightness level increases while the pulse of light is being emitted, determine whether a foreign substance is on a front side of the camera lens.

2. The camera system of claim 1, wherein the control device is configured to repeat processes (a)-(d) at a regular time interval.

3. The camera system of claim 1, further comprising:
a heating device configured to heat the camera lens,
wherein the control device is further configured to cause the heating device to turn on, heating the camera lens, based on a determination that a foreign substance in on the front side of the camera lens.

4. The camera system of claim 3, wherein the control device is further configured to repeat processes (a)-(d) after the camera lens has been heated by the heating device, and
based on another determination that the foreign substance is on the front side of the camera lens, generate an alarm message.

5. The camera system of claim 4, wherein the alarm message is displayed to a driver of the vehicle indicating that the foreign substance is on the camera lens.

6. The camera system of claim 1, wherein the light emitting device comprises a light emitting diode (LED).

7. The camera system of claim 1, wherein the increase in brightness level is caused by light from the light emitting device being reflected off of the camera lens.

8. The camera system of claim 7, wherein the increase in brightness level is less when a foreign substance is on the front side of the camera lens than when no foreign substance is on the front side of the camera lens.

9. The camera system of claim 2, wherein the image data from the image sensor is utilized to generate a camera image that is displayed to a driver of the vehicle, and wherein the image data generated during the second time period is not displayed as the camera image.

10. The camera system of claim 2, wherein the regular time interval is selected so as not to cause an interruption in the camera image that is perceptible by the driver of the vehicle.

11. The camera system of claim 10, wherein the image sensor is configured to capture image data at a frame rate that is greater than or equal to 60 frames per second (fps) and the regular time interval is greater than or equal to.5 seconds.

12. The camera system of claim 1, wherein the control device is further configured to distinguish between two or more types of foreign substance based on the amount by which the brightness level increases while the pulse of light is being emitted.

13. The camera system of claim 12, wherein the control device is further configured to cause a heating device to turn on, heating the camera lens, based on a determination that a water-based type of foreign substance is on the front side of the camera lens.

14. The camera system of claim 13, wherein the control device is further configured to generate an alarm message based on a determination that a non-water-based type of foreign substance is on the front side of the camera lens.

15. The camera system of claim 13, wherein the control device is further configured to cause water to be sprayed on the camera lens based on a determination that a non-water-based type of foreign substance is on the front side of the camera lens.

16. A method of detecting foreign substances on a camera lens of a camera system for a motor vehicle, comprising:
emitting a pulse of light onto a back side of the camera lens;
measuring a first brightness level of light received from the camera lens during a first time period before the pulse of light is emitted;
measuring a second brightness level of light received from the camera lens during a second time period while the pulse of light is being emitted;
measuring a third brightness level of light received from the camera lens during a third time period after the pulse of light has been emitted;
comparing the second brightness level with the first and/or third brightness levels to determine an amount by which brightness increases while the pulse of light is being emitted; and
based on the amount by which brightness increases while the pulse of light is being emitted, determining whether a foreign substance is on a front side of the camera lens.

17. The method of claim 16, further comprising:
based on a determination that a foreign substance is on the front side of the camera lens, causing the camera lens to be heated.

18. The method of claim 17, further comprising:
repeating the steps of claim 16 after the camera lens has been heated; and
based on a subsequent determination that the foreign substance is on the front side of the camera lens after the camera lens has been heated. generating an alarm message.
